(19) United States
(12) Patent Application Publication
(10) Pub. No.: US 2007/0230911 A1
(43) Pub. Date: Oct. 4, 2007

(54) VIDEO/AUDIO REPRODUCING DEVICE AND VIDEO/AUDIO REPRODUCING METHOD

(75) Inventor: Setsuo TERASAKI, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/695,284

(22) Filed: Apr. 2, 2007

(30) Foreign Application Priority Data
Apr. 3, 2006 (JP) 2006-102194

(51) Int. Cl. H04N 7/00

(52) U.S. Cl. 386/96

(57) ABSTRACT

A video/audio reproducing device has a contents discriminating section which discriminates whether contents of data recorded in a first recording medium and contents of data stored in a second storage medium are still image data, moving image data, or audio data; a contents display section which displays contents of data discriminated by the contents discriminating section; a video switching section which switches and outputs the still image data and the moving image data which are stored in the first and second recording media; an audio switching section which switches and outputs the audio data stored in the first or second recording medium; a switch input section which controls switching of the outputs of the video switching section and the audio switching section according to an input of a selection signal for selecting data to be reproduced; a video output section which outputs still images or moving images on the basis of the output of the video switching section; and an audio output section which outputs audio on the basis of the output of the audio switching section.

### CROSS-REFERENCE TO RELATED APPLICATION

This application is based upon and claims the benefit of priority from the prior Japanese Patent Application No. 2006-102194, filed on Apr. 3, 2006, the entire contents of which are incorporated herein by reference.

### BACKGROUND OF THE INVENTION

1. Field of the Invention

The present invention relates to a video/audio reproducing device and a video/audio reproducing method, which switch and reproduce video and audio of a plurality of recording media and an external input.

2. Background Art

Conventionally, among video/audio reproducing devices, such as for example, a car navigation system, and a car audio, there is a type to which an external input or a plurality of recording media are connected, and which performs reproduction after selecting the external input or one of the recording media.

The conventional video/audio reproducing device, which permits a user to select one supply source of video and audio from the plurality of recording media and the external input, performs processing such as decoding to image data and audio data supplied from the selected supply source and outputs video and audio (see, for example, Japanese Patent Laid-Open Publication No. 2002-175665).

However, in the above described conventional video/audio reproducing device, since one supply source is selected as the supply source of video and audio, as described above, it is not possible to perform reproduction simultaneously with the other supply source. Specifically, in the case where one supply source supplies only audio, and the other supply source supplies only still images, there is problem that it is not possible to realize a function which reproduces the audio while displaying the still images as a slide show.

Furthermore, in the above described conventional video/audio reproducing device, contents stored in a recording medium are discriminated when the recording medium is selected and the contents of the recording medium are reproduced. This may result in a trouble that it is not possible to discriminate at a time whether the contents in each recording medium are video/audio, only audio, or only still images.

### SUMMARY OF THE INVENTION

According one aspect of the present invention, there is provided: a video/audio reproducing device comprising a contents discriminating section which discriminates whether contents of data recorded in a first recording medium and contents of data stored in a second storage medium are still image data, moving image data, or audio data; a contents display section which displays contents of data discriminated by the contents discriminating section; a video switching section which switches and outputs the still image data and the moving image data which are stored in the first and second recording media; an audio switching section which switches and outputs the audio data stored in the first or second recording medium; a switch input section which controls switching of the outputs of the video switching section and the audio switching section according to an input of a selection signal for selecting data to be reproduced; a video output section which outputs still images or moving images on the basis of the output of the video switching section; and an audio output section which outputs audio on the basis of the output of the audio switching section.

According another aspect of the present invention, there is provided: a video/audio reproducing method which switches and reproduces still image data, moving image data and audio data which are recorded in a plurality of recording media, and still image data, moving image data and audio data which are externally inputted, the video/audio reproducing method comprising retrieving contents of data which are stored in the recording media or externally inputted; discriminating whether the contents of the data are still image data, moving image data, or audio data; displaying the discriminated contents of the data; according to an input of a selection signal, selecting one or two of the plurality of recording media and the external input as supply sources of still image data, moving image data and audio data; when one of the plurality of recording media and the external input is selected, discriminating whether or not the still image data or the moving image data are synchronized with the audio data, and when the still image data or the moving image data are synchronized with the audio data, reproducing the still image data or the moving image data, and the audio data; and when two of the plurality of recording media and the external input is selected, reproducing the still image data or the moving image data of the selected one, and reproducing the audio data of the selected other one.

### BRIEF DESCRIPTION OF THE DRAWINGS

FIG. 1 is a block diagram showing a main part configuration of a video/audio reproducing device according to a first embodiment which is one aspect according to the present invention;

FIG. 2 is a flow chart showing a video/audio reproducing method according to the first embodiment which is one aspect according to the present invention;

FIG. 3 is a block diagram showing a major part configuration of a video/audio reproducing device according to a second embodiment which is one aspect according to the present invention;

FIG. 4 is a figure showing a display example of data supply sources of the contents display section of the video/audio reproducing device which is one aspect according to the present invention;

FIG. 5 is a figure showing display example of the list display and the selection input of the contents display section of the video/audio reproducing device which is one aspect according to the present invention;

FIG. 6 is a figure showing display example of the list display and the selection input of the contents display section of the video/audio reproducing device which is one aspect according to the present invention;

FIG. 7 is a figure showing display example of the list display and the selection input of the contents display section of the video/audio reproducing device which is one aspect according to the present invention;

FIG. 8 is a figure showing display example of the list display and the selection input of the contents display section of the video/audio reproducing device which is one aspect according to the present invention;

FIG. 9 is a figure showing a display example of data supply sources of the contents display section of the video/audio reproducing device which is one aspect according to the present invention;

FIG. 10 is figure showing display example of the list display and the selection input of the contents display section of the video/audio reproducing device which is one aspect according to the present invention; and

FIG. 11 is figure showing display example of the list display and the selection input of the contents display section of the video/audio reproducing device which is one aspect according to the present invention.

### DETAILED DESCRIPTION

Hereafter, preferred embodiments according to the present invention will be described more specifically with reference to the accompanying drawings.

### First Embodiment

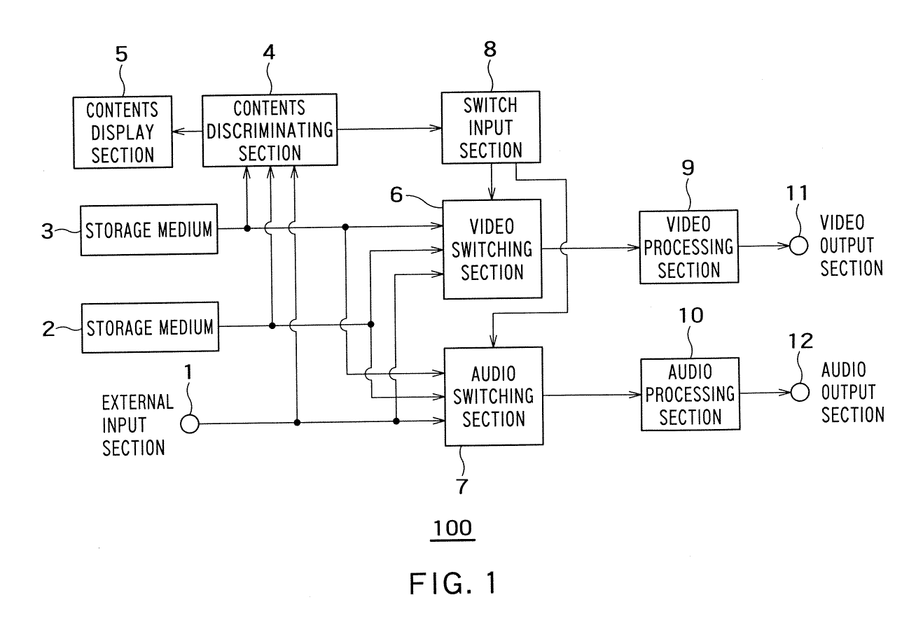

FIG. 1 is a block diagram showing a main part configuration of a video/audio reproducing device according to a first embodiment of the present invention.

As shown in FIG. 1, a video/audio reproducing device 100 includes: an external input section 1 into which at least one of still image data, moving image data, and audio data is inputted; a contents discriminating section 4 which discriminates whether respective contents of data recorded in a first recording medium 2, data stored in a second storage medium 3, and data inputted from the external input section are still image data, moving image data, or audio data; and a contents display section 5 which displays the contents discriminated by the contents discriminating section 4.

Furthermore, the video/audio reproducing device 100 includes: a video switching section 6 which switches and outputs still image data and moving image data stored in the first recording medium 2, still image data and moving image data stored in the second recording medium 3, and still image data and moving image data inputted from the external input section 1; an audio switching section 7 which switches and outputs audio data stored in the first recording medium 2, audio data stored in the second recording medium 3, and audio data inputted from the external input section 1; and a switch input section 8 which controls switching of the outputs of the video switching section 6 and the audio switching section 7 according to a selection signal for selecting data to be reproduced, which selection signal is inputted by the user viewing the contents of the contents display section 5.

Furthermore, the video/audio reproducing device 100 includes: a video processing section 9 which decodes the still image data and the moving image data outputted from the video switching section 6, and outputs the decoded signals; an audio processing section 10 which decodes the audio data outputted from the audio switching section 7 and outputs the decoded signals; a video output section 11 which outputs still images or moving images according to the output signal of the video processing section 9; and an audio output section 12 which outputs audio according to the output signal of the audio processing section 10.

The external input section 1 may be, for example, a terminal into which desired still image data, moving image data and audio data are inputted as external inputs, a terminal connected to the Internet, or a USB terminal connected to a USB memory, and the like.

It should be noted that the data inputted into the external input section 1 may be data held in the first and second recording media 2 and 3 which are included in an external device (not shown), a USB memory, and the like.

The first and second recording media 2 and 3 may be, for example, a HDD stored in the video/audio reproducing device 100, or a memory such as CD-DA, CD-ROM, CD-R, CD-RW, DVD, DVD-ROM, DVD-RW, VCD, SRAM, Flash ROM, and the like, which are contained in a slot of the video/audio reproducing device 100.

Furthermore, as described above, the first and second recording media 2 and 3 may be included in the external device (not shown), the USB memory, and the like.

When the first and second recording media 2 and 3 are optical disks, such as CD-ROM, data are read by an optical pickup, and thereafter the resultant signals are amplified. The amplified signals are binarized so that the demodulation and error correction of the data are performed. The data are recorded in the state where the image data and the audio data are distinguished from each other. When the first and second recording media 2 and 3 are DVD, VCD, and the like, the data are recorded by an MPEG-2 program stream and interleaved by being separated into image packets and audio packets. Since the packets are respectively provided with an identification flag for image or audio, on the basis of which the audio data are sent to the audio processing section 10, and the image data are sent to the video processing section 9.

It should be noted that when the first and second recording media 2 and 3 are HDDs, since data are also recorded in the disk, the processing is performed similarly to that in the case of the optical disk, except that a magnetic head is used and the modulation system is changed. Furthermore, when the first and second recording media 2 and 3 are memories, such as SRAM, the processing until demodulation is eliminated, and the succeeding processing is similarly performed.

In the contents discriminating section 4, for example, the contents of data stored in the first and second recording media 2 and 3 are discriminated on the basis of the file configuration and the management information. That is, whether the contents of stored data are only moving images, only audio, moving images and audio, or still images is discriminated by the extension of still image data, audio data, moving image and audio data, and the header information and management information of the file.

On the other hand, there may be a case where one of the audio, the still image, and the moving image to be inputted from the external input section 1 is specified by the specification of the video/audio reproducing device 100. In this case, the contents discriminating section 4 discriminates the contents of data on the basis of the specification. However, when the external input section 1 is a USB terminal and the like, the contents of data are discriminated, for example, from the file configuration and the management information. When the external input inputted to the external input section 1 is TV broadcast, the frequency band of video carrier is separated from the frequency band of audio carrier, and hence, video signals and audio signals are obtained by being separately demodulated. Furthermore, when the external input inputted to the external input section 1 is satellite broadcast, the audio carrier is similarly used at the outside of the video frequency band, and hence, the video and the audio are demodulated separately from each other. Therefore, also when the external input is broadcast, it is possible to discriminate image data and audio data.

Furthermore, the contents discriminating section 4 discriminates whether or not the moving image data and the audio data, which are stored in one of the first and second recording media 2 and 3, or inputted from the external input section 1, are synchronized with each other. When the moving image data and the audio data are synchronized with each other, the contents discriminating section 4 outputs a selection limiting signal to the switch input section 8. According to a selection signal for selecting the moving image data inputted by the user viewing the contents of the contents display section 5, the switch input section 8, which receives the selection limiting signal, controls the video switching section 6 to output the moving image data, and the audio switching section 7 to perform output switching to output the audio data synchronized with the moving image data. It should be noted that whether or not the moving image data and the audio data are synchronized with each other can be discriminated, for example, by judgment whether or not the moving image data and the audio data are stored in the same file of one recording medium. That is, when the moving image data and the audio data are stored in the same file, it is discriminated that the moving image data and the audio data are synchronized with each other. When the moving image data and the audio data are not stored in the same file, it is discriminated that the moving image data and the audio data are not synchronized with each other.

The contents display section 5 is constituted, for example, by a touch panel. The user viewing the contents (such as for example, a list display of data) displayed on the touch panel operates the touch panel. As a result, a selection signal for outputting desired data is inputted into the switch input section 8.

The video processing section 9 decodes the moving image data (for example, video encoded data), and generates and outputs video signals for reproduction. Furthermore, when the still image data are also encoded data, the video processing section 9 decodes the still image data and outputs still image signals.

The audio processing section 10 decodes the audio data (for example, audio encoded data), converts the decoded data into analog signals by a D/A converter, and outputs the signals as audio signals for reproduction via an amplifier.

The above described configuration makes it possible for the user to discriminate the contents from the external input or in the recording medium at a time with the contents display section 5, and the video switching section 6 and the audio switching section 7 are respectively provided, which makes it possible to select the contents for each of video and audio from the external input or the recording medium.

Next, an operation of the video/audio reproducing device 100 having the above described configuration and functions, that is, a video/audio reproducing method which switches and reproduces still image data, moving image data and audio data recorded in a plurality of recording media, and still image data, moving image data and audio data externally inputted, will be described below with reference to flow charts.

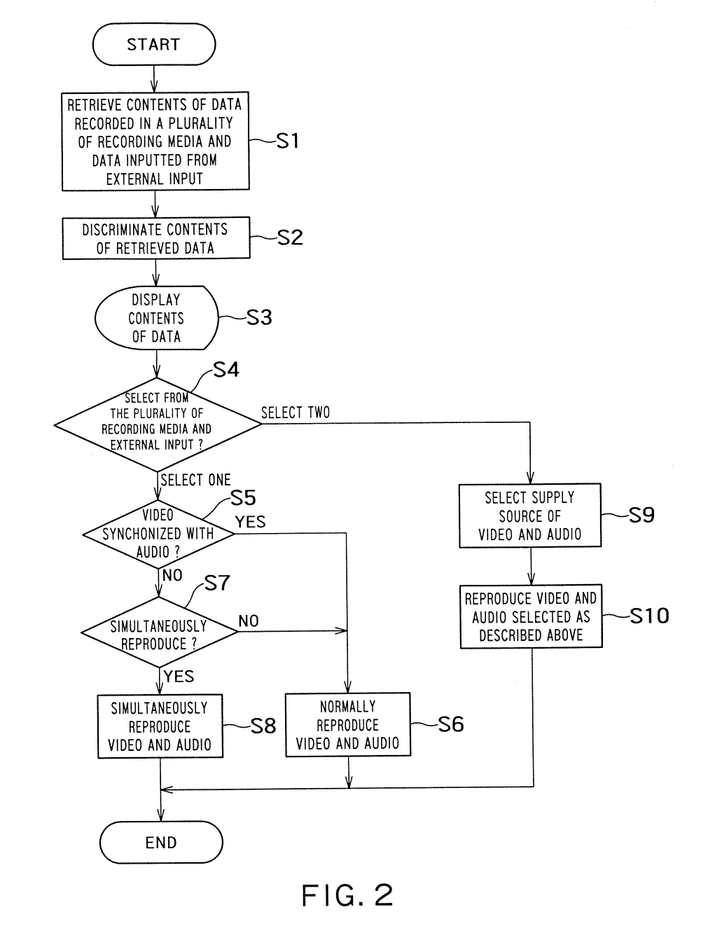

FIG. 2 is a flow chart showing a video/audio reproducing method according to the first embodiment of the present invention.

As shown in FIG. 2, first, the contents discriminating section 4 retrieves contents of data which are stored in the first and second recording media 2 and 3 and are externally inputted from the external input section 1 (step S1).

Next, the contents discriminating section 4 discriminates whether the contents of data are still image data, moving image data, or audio data (step S2).

Next, the contents display section 5 displays the discriminated contents of data (step S3).

Next, according to a selection signal inputted by the user viewing the contents of the contents display section 5, one or two of the first and second recording media 2 and 3 and the external input are selected as supply sources of still image data, moving image data, and audio data (step S4).

When one of the first and second recording media 2 and 3, and the external input is selected as the supply source of still image data, moving image data, and audio data in step S4, whether or not the still image data or the moving image data are synchronized with the audio data is discriminated (step S5).

Then, when the still image data or the moving image data are synchronized with the audio data, according to the selection signal inputted by the user, the still image data or the moving image data, and the audio data are normally reproduced (step S6).

Furthermore, when the still image data or the moving image data are not synchronized with the audio data, according to the selection signal inputted by the user, whether or not the still image data or the moving image data, and the audio data are simultaneously reproduced is judged by the switch input section 8 (step S7).

Then, when the switch input section 8, according to the selection signal inputted by the user, judges that the still image data or the moving image data, and the audio data are simultaneously reproduced, the switch input section 8 outputs a control signal and controls the video switching section 6 and the audio switching section 7 so that video and audio are simultaneously outputted from the video output section 11 and the audio output section 12, respectively (step S8).

When the switch input section 8, according to the selection signal inputted by the user, judges that the still image data or the moving image data, and the audio data are separately reproduced, video and audio are normally reproduced in step S6.

On the other hand, when two of the first and second recording media 2 and 3, and the external input are selected as supply sources of still image data, moving image data, and audio data in step S4, according to the selection signal inputted by the user, the selected one is used as the supply source of still image data or moving image data, and the selected other one is used as the supply source of audio data (step S9).

Next, the still image data or the moving image data of the selected one are reproduced, and the audio data of the selected other one are also reproduced (step S10).

Through the above described flow, the operation for switching and reproducing video and audio by the video/audio reproducing device 100 is completed.

It should be noted that when only one type of still image data, moving image data, and audio data is included in the one data supply source selected in step S4, the one type of data is reproduced through step S5, step S7 and step S6.

The above described flow of control makes it possible to display a list of contents of all the connected data supply sources, and to separately select video and audio from all the supply sources for simultaneous reproduction of the selected audio and video.

Furthermore, even when one data supply source is selected, video and audio can also be simultaneously reproduced from the data supply source in which the video and the audio are separated from each other.

As described above, the video/audio reproducing device according to the present embodiment makes it possible for the user to easily discriminate the contents of data of a plurality of recording media and an external input, and select each of video and audio by using the plurality of recording media and the external input as supply sources of the video and the audio.

That is, for example, when the contents of the first recording medium are still image data, and the second recording medium are audio data, the video/audio reproducing device is capable of reproducing the audio of the second recording medium while displaying the still images of the first recording medium as a slide show.

It should be noted that in the present embodiment, a configuration in which the video/audio reproducing device has the first and second recording media and the external input section, is explained, but the external input section may be omitted. Even in this case, the similar operating effect can also be obtained.

### Second Embodiment

In the first embodiment, for example, a configuration in which video data and audio data are separately switched and outputted is described, but in the present embodiment, a configuration is described in which a data supply source switching section which performs switching for each data supply source is further provided.

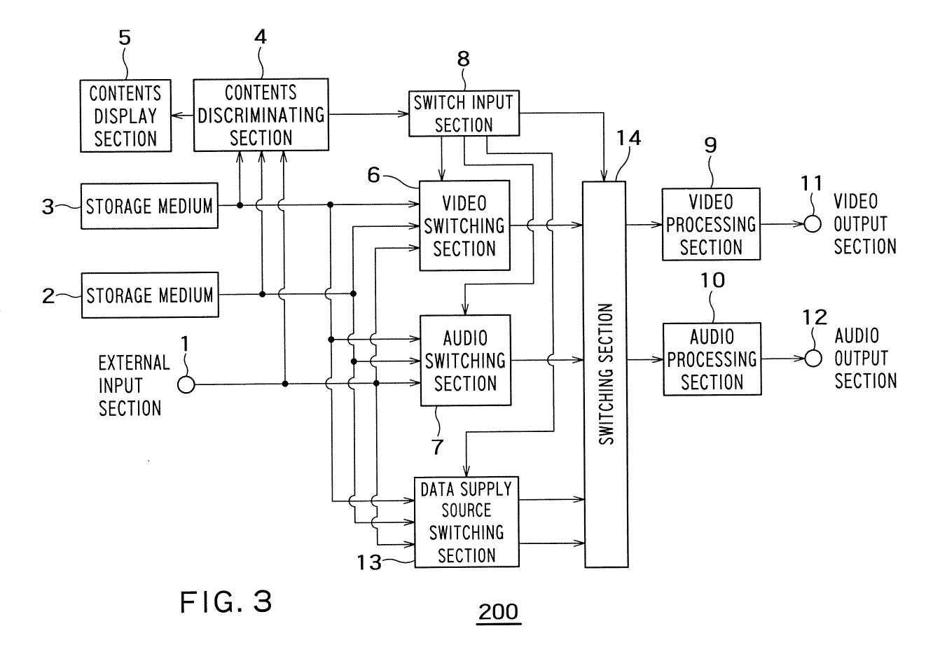

FIG. 3 is a block diagram showing a major part configuration of a video/audio reproducing device 200 according to a second embodiment which is one aspect of the present invention. It should be noted that in the figure, the same reference numerals as those in the first embodiment denote the same components as those in the first embodiment.

As shown in FIG. 3, a video/audio reproducing device 200 further includes: a data supply source switching section 13 to which data of a first and second recording media 2 and 3, and an external input section 5, that are data supply sources, are inputted, and which switches and outputs the data on the basis of a control signal of a switch input section 8; and a switching section 14 which switches and outputs the outputs of the data supply source switching section 13, outputs of a video switching section 6, and outputs of an audio switching section 7 to a video processing section 9 and an audio processing section 10 on the basis of the control signal of the switch input section 8.

When the data supply sources are switched, the image data (still image data, moving image data) and audio data from the data supply source switching section 13 are outputted by the switching section 14. When the image data and the audio data are switched, the image data from the video switching section 6 and the audio data from the audio switching section 7 are outputted by the switching section 14.

This makes it possible for the user to select each of the data supply sources or each of the image data and the audio data from the contents of the contents display section 5.

The image data selected by the switching section 14 is outputted as video from a video output section 11 via the video processing section 6. On the other hand, the audio data selected by the switching section 14 is outputted as audio from an audio output section 12 via the audio processing section 10.

The above described configuration makes it possible for the user to discriminate the contents of the external input or the recording media at a time with the contents display section 5. The video switching section 6, the audio switching section 7, and the data supply source switching section 14 are also provided. As a result, it is possible for the user to select each of video and audio from the external input or the recording media, and further to select each of the data supply sources.

As described above, the video/audio reproducing device according to the present embodiment makes it possible for the user to easily discriminate the contents of data of a plurality of recording media and an external input, to select each of video and audio by using the plurality of recording media and the external input as supply sources of the video and the audio, and to further select each of the data supply sources.

It should be noted that in the present embodiment, a case where two recording media and one external input are provided is explained, but one recording medium and one external input may also be provided.

### Third Embodiment

In the first and second embodiments, for example, overall configurations of the video/audio reproducing devices are described, but in the present embodiment, display examples of the contents display section are particularly described.

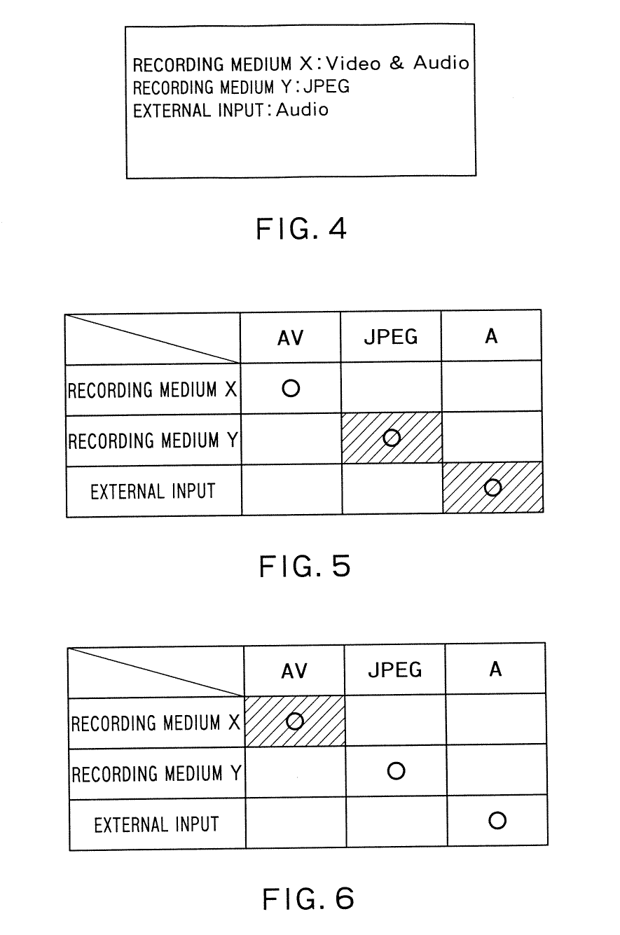

FIG. 4 is a figure showing a display example of data supply sources of the contents display section of the video/audio reproducing device which is one aspect according to the present invention.

FIG. 4 shows a case where the data supply sources are a recording medium X (first recording medium), a recording medium Y (second recording medium), and an external input. The contents of the recording medium X are Video & Audio (so-called AV) which are simultaneously reproduced, the contents of the recording medium Y are still images of JPEG (Joint Photographic Experts Group), and the external input is Audio.

FIG. 5 to FIG. 8 are figures showing display examples of the list display and the selection input of the contents display section of the video/audio reproducing device which is one aspect according to the present invention. It should be noted that data supply sources connected to the video/audio reproducing device are the same as the data supply sources in FIG. 4.

In FIG. 5, the recording medium X, the recording medium Y, and the external input along the vertical axis represent data supply sources. Furthermore, AV, JPEG and A along the horizontal axis represent contents of data, of which AV represents Audio & Video which are to be simultaneously reproduced, JPEG represents still images, and A represents audio. And the contents of each data are indicated at a place where the vertical axis and the horizontal axis intersect and a mark ∘ is displayed. From the list display in FIG. 5, it can be understood at a glance that the content of the recording medium X is AV, the content of the recording medium Y is JPEG, and the content of the external input is A.

The list display is configured for example by a touch panel, which also enables the user to input the selection signal, and in which the selected places are painted out. In FIG. 5, JPEG of the recording medium Y and A of the external input are selected, which indicates that audio is also reproduced while still images are reproduced.

In FIG. 6, AV of the recording medium X is selected, which indicates that video and audio synchronized with the video are reproduced.

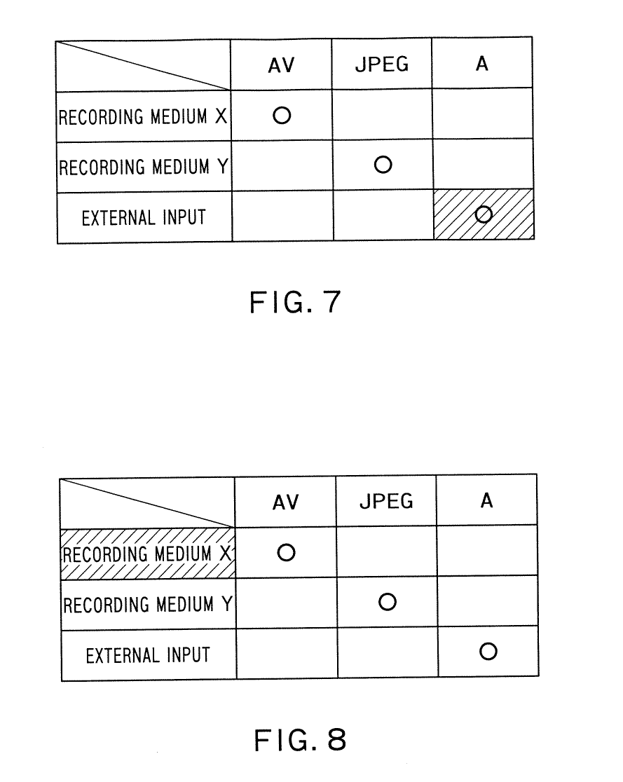

In FIG. 7, A of the external input is selected, which indicates that only audio is reproduced.

Furthermore, in FIG. 8, the recording medium X is selected as the data supply source, which indicates that video and audio which are recorded in the recording medium X and synchronized with each other, are reproduced.

By adopting the contents display and input method, as described above, it is possible to display a list of contents of all connected data supply sources, to perform a selection in this display state, and also to display the selected result.

As described above, the video/audio reproducing device according to the present embodiment makes it possible for the user to easily discriminate contents of data of a plurality of recording media and an external input, and to select each of video and audio by using the plurality of recording media and the external input as supply sources of the video and the audio.

### Fourth Embodiment

In the third embodiment, the display examples of the contents display section are described. In the present embodiment, other display examples of the contents display section are described.

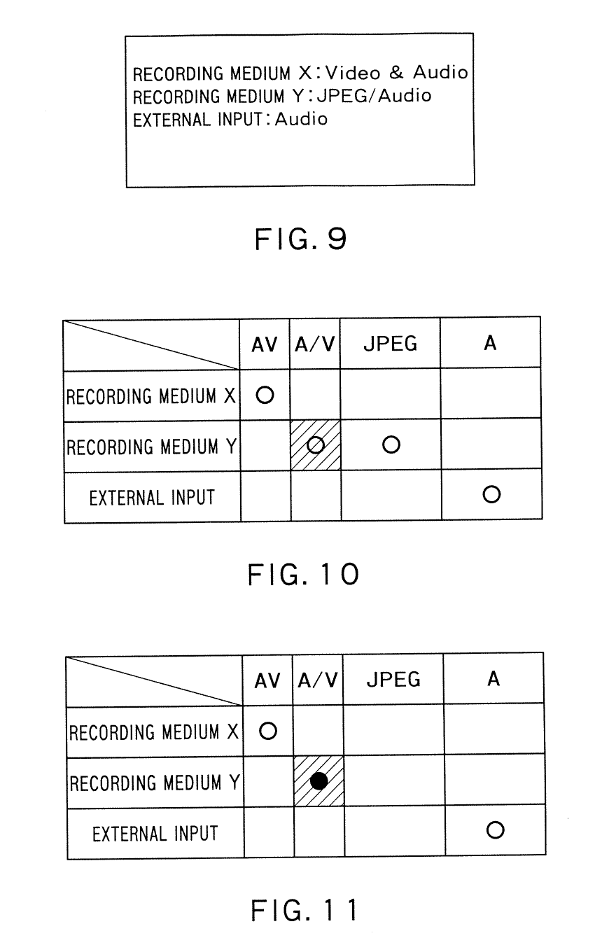

FIG. 9 is a figure showing a display example of data supply sources of the contents display section of the video/audio reproducing device which is one aspect according to the present invention.

FIG. 9 shows a case where the data supply sources are a recording medium X (first recording medium), a recording medium Y (second recording medium), and an external input. The contents of the recording medium X are Video & Audio (so-called AV) which are simultaneously reproduced, the contents of the recording medium Y are JPEG/Audio in which still images and audio are recorded in different files, and the content of the external input is Audio (audio).

Furthermore, FIG. 10 and FIG. 11 are figures showing display examples of the list display and the selection input of the contents display section of the video/audio reproducing device which is one aspect according to the present invention. It should be noted that the data supply sources connected to the video/audio reproducing device are the same as the data supply sources in FIG. 9.

In FIG. 10, the recording medium X, the recording medium Y, and the external input along the vertical axis represent data supply sources. Furthermore, AV, A/V, JPEG and A along the horizontal axis represent contents of data, of which AV represents Audio & Video which are to be simultaneously reproduced, A/V represents video and audio which are separately recorded, JPEG represents still images, and A represents audio. Also, the contents of each data are indicated at a place where the vertical axis and the horizontal axis intersect and a mark ∘ is displayed.

From the list display in FIG. 10, it can be understood at a glance that the recording medium X is AV, the recording medium Y is A/V, and the external input is A.

Similarly to the third embodiment, the list display is configured for example by a touch panel, which also enables the user to input the selection signal, and in which the selected place is painted out.

In both FIG. 10 and FIG. 11, A/V of the recording medium Y is selected. Here, FIG. 10 shows that video and audio are normally reproduced, that is, are separately reproduced. On the other hand, FIG. 11 shows that a mark ∘ is painted out to become a mark ●, which indicates that the video and audio which are separately recorded are simultaneously reproduced. The switching from the mark ∘ to the mark ● for simultaneous reproduction, and the switching from the mark ● to the mark ∘ for normal reproduction may be effected, for example, by a re-clicking operation on the touch panel.

By adopting the contents display and input method, and the selection display method, as described above, it is possible to discriminate whether video and audio in the same data supply source are to be simultaneously reproduced or separately reproduced. Furthermore, it is also possible to easily select whether video and audio to be separately reproduced are separately reproduced or simultaneously reproduced, and to also display the selected result.

As described above, the video/audio reproducing device according to the present embodiment makes it possible for the user to easily discriminate the contents of data of a plurality of recording media and an external input, to select each of video and audio by using the plurality of recording media and the external input as supply sources of the video and the audio, and to select the simultaneous reproduction or the normal reproduction.

It should be noted that in the above described third and fourth embodiments, the display of “A/V” is used, but a display of “A/J” may also be used. “J” in this case represents JPEG.

What is claimed is:

1. A video/audio reproducing device comprising:
a contents discriminating section which discriminates whether contents of data recorded in a first recording medium and contents of data stored in a second storage medium are still image data, moving image data, or audio data;
a contents display section which displays contents of data discriminated by the contents discriminating section;
a video switching section which switches and outputs the still image data and the moving image data which are stored in the first and second recording media;
an audio switching section which switches and outputs the audio data stored in the first or second recording medium;
a switch input section which controls switching of the outputs of the video switching section and the audio switching section according to an input of a selection signal for selecting data to be reproduced;
a video output section which outputs still images or moving images on the basis of the output of the video switching section; and
an audio output section which outputs audio on the basis of the output of the audio switching section.

2. The video/audio reproducing device according to claim 1, further comprising
an external input section into which at least any one of still image data, moving image data, and audio data is inputted,
wherein the contents discriminating section further discriminates whether contents of data inputted from the external input section are still image data, moving image data, or audio data;
wherein the video switching section switches and outputs still image data and moving image data which are stored in the first and second recording media, and still image data and moving image data which are inputted from the external input section; and
wherein the audio switching section switches and outputs the audio data stored in the first or second recording medium and the audio data inputted from the external input section.

3. The video/audio reproducing device according to claim 1,
wherein the contents discriminating section discriminates whether the moving image data and the audio data which are stored in one of the first and second recording media are synchronized with each other, and when the moving image data and the audio data are synchronized with each other, outputs a selection limiting signal to the switch input section, and
wherein the switch input section which receives the selection limiting signal, according to the input of the selection signal for selecting the moving image data, controls the video switching section to output the moving image data, and controls the audio switching section to perform output switching to output the audio data synchronized with the moving image data.

4. The video/audio reproducing device according to claim 2,
wherein the contents discriminating section discriminates whether the moving image data and the audio data which are stored in one of the first and second recording media or inputted from an external input are synchronized with each other, and when the moving image data and the audio data are synchronized with each other, outputs a selection limiting signal to the switch input section, and
wherein the switch input section which receives the selection limiting signal, according to the input of the selection signal for selecting the moving image data, controls the video switching section to output the moving image data, and controls the audio switching section to perform output switching to output the audio data synchronized with the moving image data.

5. The video/audio reproducing device according to claim 1,
wherein the contents display section is constituted by a touch panel, and
wherein the selection signal is inputted by operating the touch panel.

6. The video/audio reproducing device according to claim 2,
wherein the contents display section is constituted by a touch panel, and
wherein the selection signal is inputted by operating the touch panel.

7. The video/audio reproducing device according to claim 3,
wherein the contents display section is constituted by a touch panel, and
wherein the selection signal is inputted by operating the touch panel.

8. The video/audio reproducing device according to claim 4,
wherein the contents display section is constituted by a touch panel, and
wherein the selection signal is inputted by operating the touch panel.

9. The video/audio reproducing device according to claim 1, further comprising the first recording medium and the second recording medium.

10. The video/audio reproducing device according to claim 9, wherein each of the first recording medium and the second recording medium is any one of HDD stored in the video/audio reproducing device or CD-DA, CD-ROM, CD-R, CD-RW, DVD, DVD-ROM, DVD-RW, VCD, SRAM, and Flash ROM which are contained in a slot of the video/audio reproducing device.

11. A video/audio reproducing method which switches and reproduces still image data, moving image data and audio data which are recorded in a plurality of recording media, and still image data, moving image data and audio data which are externally inputted, the video/audio reproducing method comprising:
retrieving contents of data which are stored in the recording media or externally inputted;
discriminating whether the contents of the data are still image data, moving image data, or audio data;
displaying the discriminated contents of the data;
according to an input of a selection signal, selecting one or two of the plurality of recording media and the external input as supply sources of still image data, moving image data and audio data;
when one of the plurality of recording media and the external input is selected, discriminating whether or not the still image data or the moving image data are synchronized with the audio data, and when the still image data or the moving image data are synchronized with the audio data, reproducing the still image data or the moving image data, and the audio data; and
when two of the plurality of recording media and the external input is selected, reproducing the still image data or the moving image data of the selected one, and reproducing the audio data of the selected other one.

12. The video/audio reproducing method according to claim 11, further comprising:
when one of the plurality of recording media and the external input is selected, discriminating whether or not the still image data or the moving image data is synchronized with the audio data, and when the still image data or the moving image data is not synchronized with the audio data, simultaneously reproducing the still image data or the moving image data, and the audio data according to the input of the selection signal.

13. The video/audio reproducing method according to claim 11, further comprising:
when one of the plurality of recording media and the external input is selected, discriminating whether or not the still image data or the moving image data is synchronized with the audio data, and when the still image data or the moving image data is not synchronized with the audio data, respectively reproducing the still image data or the moving image data, and the audio data according to the input of the selection signal.
